(19) United States
(12) Patent Application Publication
(10) Pub. No.: US 2025/0113401 A1
(43) Pub. Date: Apr. 3, 2025

(54) CONTROL METHOD AND DEVICE

(71) Applicant: Lenovo (Beijing) Limited, Beijing (CN)

(72) Inventors: Leilei ZHAO, Beijing (CN); Jiao WANG, Beijing (CN)

(21) Appl. No.: 18/896,562

(22) Filed: Sep. 25, 2024

(30) Foreign Application Priority Data
Sep. 28, 2023 (CN) 202311285297.6

(51) Int. Cl. H04W 76/14

(52) U.S. Cl. CPC H04W 76/14

(57) ABSTRACT

A control method includes: obtaining target reference information, the target reference information being used to at least characterize a signal parameter of a target communication signal between an electronic device and a terminal device; and controlling a communication connection state with the terminal device based on connection configuration information corresponding to the terminal device and the target reference information, the connection configuration information being information of the communication signal required to configure the terminal device to establish or disconnect the target communication connection with the electronic device, and the connection configuration information configured for different terminal devices being same or different.

### CROSS-REFERENCES TO RELATED APPLICATION

This application claims priority to Chinese Patent Application No. 202311285297.6 filed on Sep. 28, 2023, the entire content of which is incorporated herein by reference.

### FIELD OF TECHNOLOGY

The present disclosure relates to the field of control technology and, more specifically, a control method and a control device.

### BACKGROUND

Short-range wireless connection technologies, such as Bluetooth connection technology, are widely used. However, in certain use scenarios, a user does not want to connect to a certain Bluetooth device, but the user device is automatically connected because the distance between the user device and the Bluetooth device has become shorter; or, after the user device establishes a connection with another Bluetooth device, the user walks away but the Bluetooth connection still stays on. These situations affect user experience of electronic devices.

### SUMMARY

One aspect of this disclosure provides a control method. The control method includes obtaining target reference information, the target reference information being used to at least characterize a signal parameter of a target communication signal between an electronic device and a terminal device; and controlling a communication connection state with the terminal device based on connection configuration information corresponding to the terminal device and the target reference information. The connection configuration information is information of the communication signal required to configure the terminal device to establish or disconnect the target communication connection with the electronic device. The connection configuration information configured for different terminal devices is the same or different.

Another aspect of the present disclosure provides a control device. The control device includes an information acquisition module and a state control module. The information acquisition module is configured to obtain target reference information. The target reference information is used to at least characterize a signal parameter of a target communication signal between the electronic device and a terminal device. The state control module is configured to control a communication connection state with the terminal device based on connection configuration information corresponding to the terminal device and the target reference information. The connection configuration information is information of the communication signal required to configure the terminal device to establish or disconnect the target communication connection with the electronic device. The connection configuration information configured for different terminal devices is the same or different.

Another aspect of the present disclosure provides computer readable storage medium storing computer instructions. When executed by one or more processors, the computer instructions implement a control method. The control method includes obtaining target reference information, the target reference information being used to at least characterize a signal parameter of a target communication signal between an electronic device and a terminal device; and controlling a communication connection state with the terminal device based on connection configuration information corresponding to the terminal device and the target reference information. The connection configuration information is information of the communication signal required to configure the terminal device to establish or disconnect the target communication connection with the electronic device. The connection configuration information configured for different terminal devices is the same or different.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

FIG. 1 is a flowchart of a control method according to some embodiments of the present disclosure.

FIG. 2 is a flowchart of a communication connection state between control devices according to some embodiments of the present disclosure.

FIG. 3 is a schematic structural diagram of a control device according to some embodiments of the present disclosure.

FIG. 4 is a schematic structural diagram of an electronic device according to some embodiments of the present disclosure.

### DETAILED DESCRIPTION

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

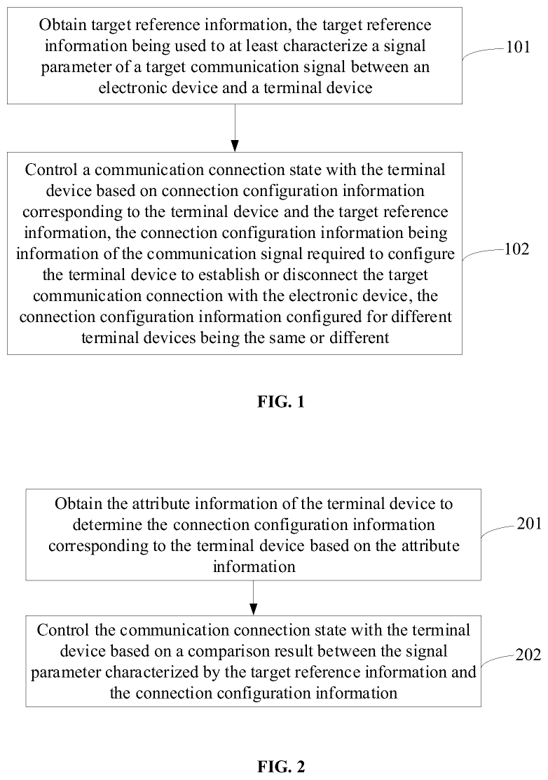

FIG. 1 is a flowchart of a control method according to some embodiments of the present disclosure. The method will be described in detail below.

101, obtaining target reference information, the target reference information being used to at least characterize a signal parameter of a target communication signal between an electronic device and a terminal device.

The electronic device may be a device that can establish a target communication connection with the terminal, such as a Bluetooth speaker, a route, a screen projection device or other computer devices. The terminal device may include, but is not limited to, a smart phone, a tablet computer, a wearable device, a personal computer (PC), a notebook, etc., which is not limited in the embodiments of the present disclosure. The electronic device and the terminal device may be of the same type or different types.

The target communication signal may include, but is not limited to, Bluetooth, Wi-Fi, screen projection signal or other point-to-point data transmission signals. The signal parameter may include at least one of signal strength, signal quality, signal delay, and data transmission rate.

102, controlling a communication connection state with the terminal device based on connection configuration information corresponding to the terminal device and the target reference information.

The connection configuration information may be information of the communication signal required to configure the terminal device to establish or disconnect the target communication connection with the electronic device. The connection configuration information configured for different terminal devices may be the same or different.

In the embodiments of the present disclosure, the terminal device connected to the electronic device can be one or more. Different terminal devices may have corresponding connection configuration information. The connection configuration information may be the default configuration information or the configuration information set by the user based on his/her needs. The connection configuration information of different terminal devices may be the same or different. The connection configuration information may be configured through a configuration interface, or through other methods such as voice configuration, shortcut key configuration, gesture configuration, etc., or may be automatically configurated based on the device type. The configuration implementation of the connection configuration information of the present disclosure will be described in detail in the following embodiments, and will not be described in detail here.

The communication connection state between the electronic device and the terminal device may include, but is not limited to, establishing a connection, disconnecting a connection, maintaining a connection, or entering a different connection state, such as increasing the data transmission interval, reducing the communication power, etc., on the basis of maintaining the connection.

The connection configuration information may be obtained by the electronic device during handshake communication with the terminal before the target communication connection is established with the terminal, or may be obtained from the terminal device after the target communication connection is established with the electronic device. The information of the communication signal required for establishing or disconnecting the target communication connection between the electronic device and the terminal device may be the signal parameter of the target communication signal, such as signal strength, signal quality, etc. For example, the information of the communication signal required may be the signal strength between the electronic device and the terminal reaching 70%.

For example, the connection configuration information may indicate that the signal strength of the communication signal needs to reach 70% in order for the terminal device to establish the target communication connection with the electronic device. If the signal strength of the target communication signal characterized by the target reference information reaches 70%, the target communication connection can be established; if it does not reach 70%, the target communication connection cannot be established with the electronic device.

In another example, the connection configuration information may indicate the signal strength of the communication signal needs to be less than 50% in order for the terminal device to disconnect the target communication connection with the electronic device. If the signal strength of the target communication signal is lower than 50%, the target communication connection can be disconnected.

Consistent with the present disclosure, the control method can control the communication connection state between the electronic device and the terminal device based on the connection configuration information corresponding to the terminal device and the target reference information between the electronic device and the terminal device. Therefore, in the implementation, the communication connection state of the electronic device and the terminal device in some specific states can be controlled by configuring the connection configuration information to better meet the users' actual needs and improve the user experience.

In some embodiments, configuring the terminal device to establish or disconnect the communication signal required for the target communication connection with the electronic device may include inputting a target signal parameter for configuring a communication signal required to establish or disconnect the target communication connection into a configuration interface of a target communication module of the electronic device.

The target communication module may include, but is not limited to, a Bluetooth communication module, a Wi-Fi communication module, a screen projection module, etc. The target signal parameter for configuring the communication signal required to establish or disconnect the target communication connection may be input in the configuration interface of the target communication module. For example, the signal strength of the communication signal required to establish the target communication connection may be configured to reaching 80%, and the signal strength of the communication signal required to disconnect the target communication connection may be configured to be less than 60% by operating the UI controls on the UI interface of the target communication module.

In some embodiments, configuring the terminal device to establish or disconnect the communication signal required for the target communication connection with the electronic device may include inputting the target signal parameter for configuring a communication signal required to establish or disconnect the target communication connection through a voice input module of the electronic device.

The target signal parameter of the required communication signal may be configured through the voice input module, that is, the configuration of relevant signal parameter may be realized through voice. In the implementation of voice configuration of related signal parameters, the user may complete the configuration through one voice command, or through multiple voice commands in interactive communication with the electronic device. For example, a user can configure the target signal parameter through the voice command of “Student **, please adjust the Bluetooth connection signal threshold of ** mobile phone 75%”. In another example, the user can first say the electronic device identification name “**” to wake up the device. After the device answers, the user can input the voice command of “Set communication connection parameters”. After the device responds with the voice message of “Please start configuration”, the user then enters “Adjust the Bluetooth connection signal threshold of ** mobile phone 75%”, thereby completing the configuration of the target signal parameter through multiple voice commands.

In some embodiments, configuring the terminal device to establish or disconnect the communication signal required for the target communication connection with the electronic device may include configuring the target signal parameter of the communication signal required to establish or disconnection the target communication connection by inputting operations on target controls and/or physical buttons arranged of the electronic device.

The relevant signal parameters may be configured through the controls on the display interface or the shortcut physical keys on the electronic device. For example, a setting control may be arranged on the display interface of the electronic device, and the size of the target signal parameter may be set by clicking on the control. Alternatively, the target signal parameter may be set by at least one physical button arranged on the housing of the electronic device, such as first pressing the mode key to switch to the signal parameter configuration mode, and then setting the target signal parameters with the up button and/or the down button. The step size of increasing and decreasing may be the default configuration step sizes, or may be set by the user based on needs.

In some embodiments, configuring the terminal device to establish or disconnect the communication signal required for the target communication connection with the electronic device may include inputting the target signal parameter for configuring the communication signal required to establish or disconnect the target communication connection through an action recognition module of the electronic device.

The action recognition module may include an image recognition module, a time-of-flight (TOF) sensor, a radar, an ultrasonic recognition module, or other modules capable of recognizing specific actions or gestures. The electronic device stores the corresponding relationship between actions or gestures and parameter configuration operations. Therefore, after the action recognition module recognizes a specific action or gesture, the parameter configuration operation can be determined based on the preset mapping relationship to complete the configuration of the target signal parameter. For example, the user first opens his palm in front of the electronic device to cause the electronic device to enter the configuration mode. Then the user pushes his palm to the left to control the corresponding target signal parameter to decrease. In addition, the user can also push his palm to the right to control the corresponding target signal parameter to increase.

In some embodiments, configuring the terminal device to establish or disconnect the communication signal required for the target communication connection with the electronic device may include configuring the target signal parameter of the communication signal required to establish or disconnect the target communication connection based on attribute information of the terminal device.

The attribute information may include the type of terminal device, hardware configuration information, etc. The attribute information may be automatically configured based on historical data or big data. For example, if the hardware configuration of the big data representation terminal device includes a communication module using a certain protocol, the corresponding target signal parameter can be configured based on the communication module of the certain protocol supported by the terminal device.

The above description provides multiple implementations of the communication signal required for configuring the terminal device to establish or disconnect the target communication connection with the electronic device, but the configuration of the communication signal is not limited thereto.

There are many methods for inputting the target signal parameter for configuring the communication signal required to establish or disconnect the target communication connection in the configuration interface of the target communication module of the electronic device. Several examples are described in detail below.

In some embodiments, inputting the target signal parameter in the configuration interface may include, in response to obtaining a first operation, displaying and outputting a first configuration interface of the target communication module of the electronic device. The first configuration interface may include a first control and a second control. The first signal parameter of the communication signal required to establish the target communication connection may be configured by the configuration operation on the first control, and the second signal parameter of the communication signal required to disconnect the target communication connection may be configured by the configuration operation on the second control. The first signal parameter may be the same or different from the second signal parameter.

The first operation may be an operation that can call up the configuration interface of a communication module such as the Bluetooth module or the Wi-Fi module, and the first operation may be a touch operation, a voice operation, a gesture operation, etc. After the user inputs the first operation, the electronic device may respond to the operation, and display and output the first configuration interface of the target communication module. The first control on the first configuration interface may be used to set the signal parameter of the communication signal required to establish the target communication connection, and the second may be used to set the signal parameter of the communication signal to disconnect the target communication connection. For example, the first control and the second control may be both a touch bar, each touch bar having a progress point. The user may drag or slide the progress point with a finger to adjust the value of the corresponding signal parameter. The signal parameter may be signal strength, signal quality, transmission power, etc. such that the signal strength, signal quality or transmission power, etc. can be adjusted by controlling the progress point on the touch bar.

In some embodiments, the first control and the second control may be used to adjust only one signal parameter, such as only adjusting the signal strength. However, in other embodiments, the adjustment of various signal parameters may also be realized through the first control and the second control. For example, the first configuration interface may include a first control, a second control, and a switching control with different signal parameters. In this way, when the user selects different signal parameters, the signal parameter threshold for establishing the target communication connection may be adjusted through the first control, and the signal parameter threshold for disconnecting the target communication connection may be adjusted through the second control.

In some embodiments, inputting the target signal parameter for configuring the communication signal required to establish or disconnect the target communication connection on the configuration interface of the target communication module of the electronic device may include, in response to obtaining a second operation, displaying and outputting a second configuration interface of the target communication module of the electronic device. At least one first signal parameter of the communication signal required to establish the target communication connection may be configured through a configuration operation of at least one sub-control of the first control, and at least one second signal parameter of the communication signal required to disconnect the target communication connection may be configured through a configuration operation of at least one sub-control of the second control. The sub-control of the first control may be arranged in the second configuration interface where the first control is located or a sub-interface of the second configuration interface. The sub-control of the second control may be arranged in the second configuration interface where the second control is located or the sub-interface of the second configuration interface. The first signal parameter may be the same or different from the second signal parameter.

Similar to the first operation, the second operation may be an operation that can call up the configuration interface of the communication module such the Bluetooth module, the Wi-Fi module, etc., and the second operation may be a touch operation, a voice operation, a gesture operation, etc. The second operation may be the same or different from the first operation.

Consistent with the present disclosure, the corresponding signal parameters can be adjusted through the sub-controls of the first control and the second control. The first control and the second control may include sub-controls, and different sub-controls may be used to adjust different signal parameters. For example, the first sub-control may be a sub-control for adjusting the signal strength, and the second sub-control may be a sub-control for adjusting the signal quality. The threshold of the signal strength for establishing the target communication connection may be adjusted under the sub-control of the first control, and the threshold of the signal strength for disconnecting the target communication connection may be adjusted under the sub-control of the second control. The sub-controls may be arranged in the second configuration interface where the first control and the second control are located, such as by displaying a tree-like hierarchical structure. Alternatively, the sub-controls may also be arranged in a sub-interface at a lower level than the second configuration interface.

For example, the user touches the first control or the second control of the second configuration interface, and then the sub-interface of the next level of the second configuration interface pops up. The sub-interface displays the sub-controls of the first control or the second control, and then the user performs relevant operations on the sub-controls in the sub-interface to adjust the relevant signal parameters.

In some embodiments, inputting the target signal parameter for configuring the communication signal required to establish or disconnect the target communication connection on the configuration interface of the target communication module of the electronic device may include, in response to obtaining a third operation, displaying and outputting a third configuration interface of the target communication module of the electronic device. The third configuration interface may include a third control. At least one first signal parameter of the communication signal required to establish the target communication connection may be configured through a configuration operation on the third control, or at least one first signal parameter of the communication signal required to establish the target communication connection may be configured through a configuration operation on the sub-control of the third control. The sub-control of the third control may be arranged in a third configuration interface or a sub-interface of the third configuration interface.

Correspondingly, the parameter configuration of the communication signal for disconnecting the target communication connection may include, in response to obtaining a fourth operation, displaying and outputting a fourth configuration interface of the target communication module of the electronic device. The fourth configuration interface may include a fourth control. At least one second signal parameter of the communication signal required to disconnect the target communication connection may be configured through a configuration operation on the fourth control, or at least one second signal parameter of the communication signal required to disconnect the target communication connection may be configured through a configuration operation on the sub-control of the fourth control. The sub-control of the fourth control may be arranged in the fourth configuration interface or a sub-interface of the fourth configuration interface.

The third operation and the fourth operation may be similar to the first operation and the second operation, and may be used to call up the configuration interface of the communication module such as the Bluetooth module or the Wi-Fi module.

In some embodiments, the parameter configuration of the communication signal used to establish the target communication connection and the parameter configuration of the communication signal used to disconnect the target communication connection may not be in the same configuration interface.

For example, the user inputs a third operation to call up the third configuration interface, where the third configuration interface includes a third control for adjusting the communication signal threshold required for establishing the target communication connection. The user may complete the configuration of the signal threshold for establishing the target communication connection by inputting the signal threshold in the input box corresponding to the third control. Alternatively, the user may enter the sub-interface of the third configuration interface by touching the third control in the third configuration interface. The sub-interface may include the sub-control of the third control, and the configuration of the signal threshold for establishing the target communication connection may be completed by inputting the signal threshold in the input box corresponding to the sub-control.

For example, the user inputs a fourth operation to call up the fourth configuration interface, where the fourth configuration interface includes a fourth control for adjusting the communication signal threshold required for disconnecting the target communication connection. The user may complete the configuration of the signal threshold for disconnecting the target communication connection by inputting the signal threshold in the input box corresponding to the fourth control. Alternatively, the user may enter the sub-interface of the fourth configuration interface by touching the fourth control in the fourth configuration interface. The sub-interface may include the sub-control of the fourth control, and the configuration of the signal threshold for disconnecting the target communication connection may be completed by inputting the signal threshold in the input box corresponding to the sub-control.

The above description described several user input operations to call up the configuration interface to configure the signal parameter threshold for establishing and disconnecting the target communication connection in detail for those skilled in the art to better understand and implement the technical solutions of the present disclosure.

In some embodiments, obtaining the target reference information may include obtaining the target reference information based on relative position data between the terminal device and the electronic device.

The relative position data may represent the relative distance between the terminal device and the electronic device. In generally, the when the distance between the two is closer, the signal strength and signal quality between the two are better, and when the distance between the two is farther, the signal strength and the signal quality between the two are worse. Therefore, in some embodiments, the distance between the terminal device and the electronic device can be used as a condition for determining the target reference information.

For example, when the distance between the terminal device and the electronic device exceeds 10 meters, the signal quality between the terminal device and the electronic device can be determined to be “weak”; and when the distance between the terminal device and the electronic device is less than 3 meters, the signal quality between the terminal device and the electronic device can be determined to be “strong”.

In some embodiments, obtaining the target reference information may include obtaining the target reference information based on a working parameter of a corresponding communication module of the terminal device and/or the electronic device.

The working parameter of the corresponding communication module may be the transmission power, frequency band, antenna working state, etc. For example, the target communication connection between the terminal device and the electronic device is a Bluetooth connection, the transmission power of the terminal device is A, and the Bluetooth transmission power of the electronic device is B. If A is less than B, the small power of the two transmission powers, that is, A, can be determined as the target reference information. Or, if the Wi-Fi module of the electronic device operations in the 2.4G frequency band, and the Wi-Fi module of the terminal device operates in the 2.4G frequency band, the signal strength or signal quality of the Wi-Fi signal may be determined based on the distance between the two or whether there are obstacles.

In some embodiments, obtaining the target reference information may include obtaining the target reference information through the signal parameter of the target communication signal between the electronic device and the terminal device fed back by the target communication module or target application of the electronic device, the target application being an application program that monitors the signal parameter of the target communication signal.

For example, the target communication module is a Bluetooth module. Since the Bluetooth modules of the terminal device and the electronic device can sense or receive each other's Bluetooth signals, the Bluetooth module of the electronic device can directly determine the target reference information, that is, the signal strength, after sending or receiving the Bluetooth signal of the Bluetooth module of the terminal device.

In some embodiments, an application capable of detecting signal parameters of a target communication signal may be installed in the electronic device, that is, the target application. In this case, the target application can monitor the target communication signal between the terminal device and the electronic device, such as the Wi-Fi signal, and feed the signal parameters of the monitor Wi-Fi signal back to the electronic device. The electronic device can determine the Wi-Fi signal quality based on the data fed back by the target application.

In some embodiments, obtaining the target reference information may include obtaining the target reference information through a signal relay device arranged between the electronic device and the terminal device.

In some embodiments, the terminal device and the electronic device may not communicate directly, but through a relay device such as a router. In this way, the target reference information may be determined based on some parameters between the relay device and the two electronic devices.

For example, if a TV has established a Wi-Fi connection with a mobile phone through a router, the signal strength between the TV and the mobile phone may be determined based on the distance between the TV and the router and the distance between the mobile phone and the router. Alternatively, the router may also feed relevant speed data back to the TV based on the speed at which it transmits data between the TV and the mobile phone, and the TV may determine the signal quality based on the received speed data.

The above description described several methods of obtaining the target reference information, but the method of obtaining the target reference information is not limited thereto.

FIG. 2 is a flowchart of a communication connection state between control devices according to some embodiments of the present disclosure. The control of the communication connection state of the terminal device based on the connection configuration information corresponding to the terminal device and the target reference information may include the following processes.

201, obtaining the attribute information of the terminal device to determine the connection configuration information corresponding to the terminal device based on the attribute information.

The attribute information may include, but is not limited to, device model, type, identification, etc. For example, the attribute information of the terminal device is the device model, and the maximum limit of the transmission power of the model is M. The connection configuration information corresponding to the terminal device may be determined based on the maximum limit value M as “when the transmission power can reach 0.6M, determine to establish the target communication connection; when the transmission power is less than 0.4M, determine to disconnect the target communication connection”.

202, controlling the communication connection state with the terminal device based on a comparison result between the signal parameter characterized by the target reference information and the connection configuration information.

In case where a target communication connection is not established with the terminal device, the attribute information of the terminal device may be obtained based on a connection request of the terminal device. The first connection configuration information corresponding to the terminal device may be determined based on the attribute information. Based on a comparison result between the signal parameter and the first connection configuration information, the target communication connection may or may not be established with the terminal device.

For example, the first connection configuration information represented by the attribute information of the terminal device includes: disconnecting the Bluetooth connection when the signal strength is lower than 60%, and establishing the Bluetooth connection when the signal strength is higher than 75%. In the case where the electronic device has not established the target communication connection with the terminal device, if the signal parameter indicates that the signal strength is at 80%, which is higher than the connection threshold (80%), a Bluetooth connection between the electronic device and the terminal device can be established; if the signal parameter indicates that the signal strength is at 70%, which does not exceed the connection threshold (80%), a Bluetooth connection between the electronic device and the terminal device will not be established.

When a target communication connection is established with the terminal device, the attribute information of the terminal device may be obtained through the target communication connection. The second connection configuration information corresponding to the terminal device may be determined based on the attribute information. Based on a comparison result between the signal parameter and the second connection configuration information, the target communication connection may or may not be disconnected with the terminal device.

For example, the second connection configuration information includes disconnecting the Bluetooth connection when the signal strength is lower than 60%, and establishing the Bluetooth connection when the signal strength is higher than 80%. In the case where the terminal device and the electronic device are in a Bluetooth connection state, if the signal parameter indicates that the signal strength is at 50%, which is lower than the disconnection threshold (60%), the current Bluetooth connection will be disconnected; if the signal parameter indicates that the signal strength is at 65%, the current Bluetooth connection will be maintained.

In some embodiments, establishing or not establishing the target communication connection with the terminal device based on the comparison result between the signal parameter and the first connection configuration information may include, if the relative distance between the terminal device and the electronic device is within a first distance range, do not establish the target communication connection with the terminal device; if the relative distance between the terminal device and the electronic device is within a second distance range, establish the target communication connection with the terminal device.

The distance range between the electronic device and the terminal device can be used to represent the connection configuration information, the actual distance between the two can be used as the signal parameter, and the actual distance can be compared with the set distance range. Since the closer the distance, the better the signal, when the target communication connection between the electronic device and the terminal device is not established and the actual distance is lower than the distance threshold for establishing a connection, the target communication connection between the electronic device and the terminal device may be controlled to be established. Further, when the actual distance is greater than the distance threshold for establishing a connection, the target communication connection between the electronic device and the terminal device may not be established.

Instead of configuring the parameter thresholds based on the distance between devices, in some embodiments, the parameter thresholds may be configured based on signal strength. In this case, on one hand, if the signal strength of the target communication signal between the terminal device and the electronic device is within a first threshold range, the target communication connection with the terminal device may not be established. On the other hand, if the signal strength of the target communication signal between the terminal device and the electronic device is within a second threshold range, the target communication connection with the terminal device may be established.

Consistent with the present disclosure, the threshold range of the signal strength between the electronic device and the terminal device can represent the connection configuration information, and the actual signal strength between the two can be used as the signal parameter, and the actual signal strength can be compared with the set signal strength threshold range. Since the higher the signal strength, the better the signal, when the target communication connection is not established between the electronic device and the terminal device and the actual signal strength is higher than the signal strength threshold for establishing a connection, the target communication connection between the electronic device and the terminal device can be controlled to be established. Further, when the actual signal strength is lower than the signal strength threshold for establishing a connection, the target communication connection between the electronic device and the terminal device will not be established.

Corresponding to the foregoing description, disconnecting or not disconnecting the target communication connection with the terminal device based on the comparison result between the signal parameter and the second connection configuration information may include, if the relative distance between the terminal device and the electronic device is within a third distance range, disconnecting the target communication connection with the terminal device; if the relative distance between the terminal device and the electronic device is within a fourth distance range, do not disconnect the target communication connection with the terminal device.

The distance range between the electronic device and the terminal device can be used to represent the connection configuration information, the actual distance between the two can be used as the signal parameter, and the actual distance can be compared with the set distance range. Since the closer the distance, the better the signal, when there is no target communication connection between the electronic device and the terminal device and the actual distance is lower than the distance threshold for disconnection, the target communication connection between the electronic device and the terminal device may be controlled to be disconnected. Further, when the actual distance is greater than the distance threshold for disconnection, the target communication connection between the electronic device and the terminal device may be maintained.

When the parameter threshold is configured based on the signal strength, if the signal strength of the target communication signal between the terminal device and the electronic device is within a third threshold range, the target communication connection with the terminal device may be disconnected. Further, if the signal strength of the target communication signal between the terminal device and the electronic device is within a fourth threshold range, the target communication connection with the terminal device may not be disconnected.

Consistent with the present disclosure, the threshold range of the signal strength between the electronic device and the terminal device can represent the connection configuration information, the actual signal strength between the two can be used as a signal parameter, and the actual signal strength can be compared with the set signal strength threshold range. Since the higher the signal strength, the better the signal, when there is no target communication connection between the electronic device and the terminal device and the actual signal strength is lower than the signal strength threshold for disconnection, the target communication connection between the electronic device and the terminal device can be controlled to be disconnected. Further, when the actual signal strength is higher than the signal strength threshold for establishing a connection, the target communication connection between the electronic device and the terminal device can be maintained.

It should be noted that when configuring the parameter thresholds based on the distance between devices, the threshold for controlling the establishment of the target communication connection between the device and the threshold for controlling the disconnection of the target communication connection between devices can be the same, such as 70%. Alternatively, the thresholds can be different. For example, the threshold for establishing a target communication connection may be 80%, and the threshold for disconnecting a target communication connection may be 60%.

In some embodiments, controlling the communication connection state with the terminal device based on the connection configuration information corresponding to the terminal device and the target reference information may include, if the signal strength of the target communication signal between the terminal device and the electronic device is within a fifth threshold range, controlling the target communication module of the electronic device to enter a first working state to be in a first communication connection state with the terminal device. Alternatively, if the relative distance between the terminal device and the electronic device is within a fifth distance range, controlling the target communication module of the electronic device to enter a second working state to be in a second communication connection state with the terminal device.

The first working state and the second working state may be a lower power consumption state, which is within a threshold range between the target communication connection being disconnected and not being disconnected. For example, the threshold range for establishing a target communication connection is above 75%, and the threshold range for disconnecting the target communication connection is below 60%. In this case, the threshold range corresponding to the low power consumption state is 60%-75%. In the first working state, the target communication module on the device, such as the Bluetooth module or the Wi-Fi module, can be controlled to enter a low power consumption state to reduce the communication traffic between the electronic device and the terminal device, thereby reducing the communication bandwidth or reducing the transmission and reception frequency of the communication module.

In addition, in an application where an electronic device is connected to multiple terminal devices, if one of the terminal devices is disconnected from the target communication connection with the electronic device, the working state of the target communication module may also be controlled to be adjusted.

More specifically, if the terminal device is not unique and the relative distance between at least one of the terminal devices and the electronic device is within the third distance range, the target communication module of the electronic device may be controlled to enter a third working state to cause a terminal device within the fourth distance range from the electronic device to be in a third communication connection state with the electronic device. Further, if the terminal device is not unique and the signal strength of the target communication signal between at least one of the terminal devices and the electronic device is within the third threshold range, the target communication module of the electronic device may be controlled to enter a fourth working state to cause a terminal device within the fourth threshold range with the electronic device to be in a fourth communication connection state with the electronic device.

For example, a router has a target communication connection with multiple mobile phones. If the distance between mobile phone A and the router becomes farther and exceeds the disconnection distance threshold for disconnecting the target communication connection, the Wi-Fi connection between the router and mobile phone A can be disconnected, and the Wi-Fi module of the router can be controlled to enter a low power consumption state. In this way, the router maintains the communication connection with other mobile phones that are within the disconnection distance threshold, but maintains a connection state with low power consumption, that is, a connection state with low transmission power and bandwidth resources.

In the foregoing embodiments, different communication connection states may be the same or different, and the differences may include different frequencies of data transmission and reception, different power consumption levels, etc.

Based on the foregoing description, the control method may further include controlling the communication connection state between the terminal device based on the relative distance and/or the signal strength of the target communication signal between the signal relay device and the electronic device and/or the terminal device, the signal relay device being arranged between the electronic device and the terminal device.

For example, a target communication connection is established between a TV and a mobile phone through a relay device, router. When the user holds the mobile phone away from the router, the distance between the mobile phone and the router becomes farther, or the signal strength becomes weaker. In this case, the TV and the router can be notified to enter a low power consumption state. In the low power consumption state, the frequency of sending and receiving data between the TV and the mobile phone is reduced.

Consistent with the present disclosure, the control method can control the communication connection state between the electronic device and the terminal device based on the connection configuration information corresponding to the terminal device and the target reference information between the electronic device and the terminal device. Therefore, in the implementation, the communication connection state of the electronic device and the terminal device in some specific states can be controlled by configuring the connection configuration information to better meet the users' actual needs and improve the user experience.

To simplify description, the foregoing method embodiments are described as a series of action combinations. Those skilled in the art should be aware that the present disclosure is not limited by the described action sequence. According to the present disclosure, certain processes may be performed in another sequence or simultaneously. Those skilled in the art should also be aware that embodiments described in the specification are some embodiments, and the actions and modules involved are not necessarily required by the present disclosure.

The control method is described in detail in the embodiments of the present disclosure. The control method of the present disclosure can be implemented by various devices. Therefore, the present disclosure also provides a control device, which is described in detail below.

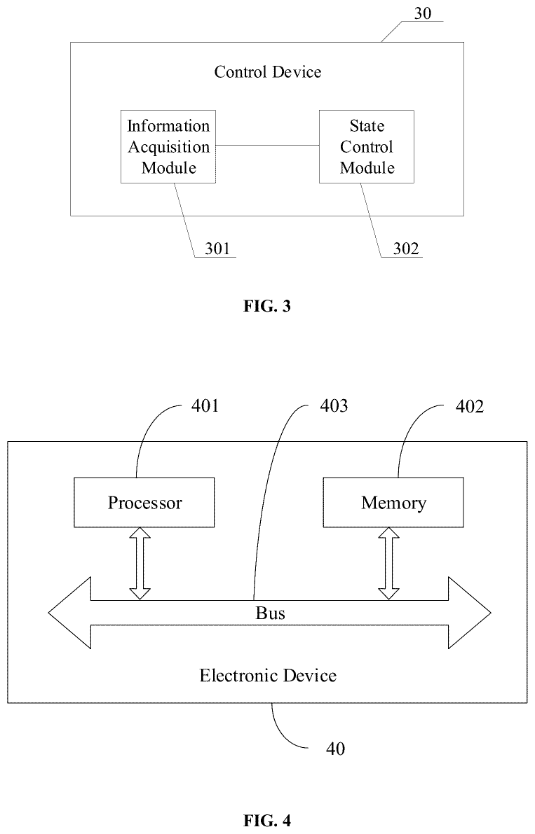

FIG. 3 is a schematic structural diagram of a control device 30 according to some embodiments of the present disclosure. As shown in FIG. 3, the control device 30 includes an information acquisition module 301 and a state control module 302.

In some embodiments, the information acquisition module 301 may be configured to obtain the target reference information, the target reference information being used to at least represent the signal parameter of a target communication signal between the electronic device and the terminal device.

In some embodiments, the state control module 302 may be configured to control the communication connection state with the terminal device based on the connection configuration information corresponding to the terminal device and the target reference information.

The connection configuration information may be information related to the communication signal required to configure the terminal device to establish or disconnect the target communication connection with the electronic device. The connection configuration information configured for different terminal devices may be the same or different.

Consistent with the present disclosure, the control device can control the communication connection state between the electronic device and the terminal device based on the connection configuration information corresponding to the terminal device and the target reference information between the electronic device and the terminal device. Therefore, in the implementation, the communication connection state of the electronic device and the terminal device in some specific states can be controlled by configuring the connection configuration information to better meet the users' actual needs and improve the user experience.

For details of the control device and the modules it contains, as well as other possible implementations, reference can be made to the corresponding parts of the method embodiment, which will not be repeated here.

In the embodiments of the present disclosure, the control device includes a processor and a memory. The information acquisition module and the state control module may be implemented by storing program modules in the memory, and executing the program modules stored in the memory by the processor to perform corresponding functions.

The processor includes a kernel, and the kernel calls the corresponding program module from the memory. There may be one or more kernels. Returned data may be processed by adjusting kernel parameters.

The memory can include a non-persistent memory, a random-access memory (RAM), and/or a non-volatile memory among computer-readable storage media, such as a read only memory (ROM) or a flash memory (flash RAM). The memory includes at least one memory chip.

The present disclosure also provides a non-transitory computer-readable storage medium on which a program is stored, and when the program is executed by a processor, the focus detection method described in the foregoing embodiments is implemented.

Embodiments of the present disclosure further provide a computer-readable storage medium, which can be directly loaded into the internal memory of the computer. The computer-readable storage medium can include software codes. After the computer program is loaded and executed by the computer, the computer can perform the control method of embodiments of the present disclosure.

Embodiments of the present disclosure further provide a computer program product including software codes, which can be directly loaded into the internal memory of the computer. After the computer program is loaded and executed by the computer, the computer can perform the control method of embodiments of the present disclosure.

Furthermore, embodiments of the present disclosure provide an electronic device. FIG. 4 is a schematic structural diagram of an electronic device 40 according to some embodiments of the present disclosure. As shown in FIG. 4, the electronic device 40 includes one or more processors 401, one or more memories 402 connected to the one or more processors, and a bus 403. The one or more processors and the one or more memories can communicate with each other via the bus. The one or more processors can be configured to call the program instructions in the one or more memories to execute the control method of embodiments of the present disclosure.

Various embodiments in the specification are described in a progressive manner, and each embodiment focuses on the differences from other embodiments, and for the same and similar parts between the various embodiments, reference can be made to each other. As for the apparatus disclosed in the embodiments, because of the correspondence to the method disclosed in the embodiments, the description is relatively simple, and reference can be made to the description of the method for relevant parts.

It should also be noted that in the specification, relational terms such as first and second are used only to distinguish one entity or operation from another, and do not necessarily require or imply that there is such actual relationship or order between those entities or operations.

Moreover, the terms “comprising,” “including” or any other variation thereof are intended to encompass non-exclusive inclusion such that a process, method, article or device comprising a list of elements includes not only those elements, but also includes not explicitly listed or other elements inherent to such a process, method, article or apparatus. Without further limitation, an element qualified by the phrase “comprising a . . . ” does not preclude the presence of additional identical elements in a process, method, article or apparatus that includes the element.

Those skilled in the art can further realize that the units and algorithm steps of the examples described in the embodiments disclosed in the specification can be implemented by electronic hardware, computer software, or a combination of both. To clearly illustrate interchangeabilities of hardware and software, the structures and steps of each example have been generally described in the specification in accordance with the functions. Whether these functions are implemented by hardware or software depends on the specific application and design constraints of the technical solution. Those skilled in the art can use different methods for each specific application to implement the described functions, but such implementation should not be considered beyond the scope of this application.

The steps of the method or algorithm described in the embodiments disclosed in the specification can be directly implemented by hardware, a software module executed by a processor, or a combination thereof. The software module can be stored in random access memory (RAM), internal memory, read-only memory (ROM), electrically programmable ROM, electrically erasable programmable ROM, registers, hard disks, removable disks, CD-ROMs, or any other storage media known in the technical field.

The above description of the disclosed embodiments enables those skilled in the art to implement or use this application. Various modifications to these embodiments will be obvious to those skilled in the art, and the general principles defined herein can be implemented in other embodiments without departing from the spirit or scope of the present application. Therefore, this application will not be limited to the embodiments shown in the specification, but should conform to the broadest scope consistent with the principles and novelties disclosed in the specification.

What is claimed is:

1. A control method comprising:
obtaining target reference information, the target reference information being used to at least characterize a signal parameter of a target communication signal between an electronic device and a terminal device; and
controlling a communication connection state with the terminal device based on connection configuration information corresponding to the terminal device and the target reference information, wherein:
the connection configuration information is information of the communication signal required to configure the terminal device to establish or disconnect the target communication connection with the electronic device, and the connection configuration information configured for different terminal devices is same or different.

2. The method of claim 1, wherein the communication signal required for configuring the terminal device to establish or disconnect the target communication connection with the electronic device includes one or more of:
inputting a target signal parameter for configuring the communication signal required to establish or disconnect the target communication connection on a configuration interface of a target communication module of the electronic device;
inputting the target signal parameter for configuring the communication signal required to establish or disconnect the target communication connection through a voice input module of the electronic device;
inputting the target signal parameter for configuring the communication signal required to establish or disconnect the target communication connection through target controls and/or physical keys arranged on the electronic device; or
inputting the target signal parameter for configuring the communication signal required to establish or disconnect the target communication connection through an action recognition module of the electronic device; or
configuring the target signal parameter of the communication signal required to establish or disconnect the target communication connection based on attribute information of the terminal device.

3. The method of claim 2, wherein inputting the target signal parameter for configuring the communication signal required to establish or disconnect the target communication connection on the configuration interface of the target communication module of the electronic device includes one or more of:
in response to obtaining a first operation, displaying and outputting a first configuration interface of the target communication module of the electronic device, the first configuration interface including a first control and a second control, a first signal parameter of the communication signal required to establish the target communication connection being configured by a configuration operation acting on the first control, a second signal parameter of the communication signal required to disconnect the target communication connection being configured by the configuration operation acting on the second control, the first signal parameter being the same as or different from the second signal parameter;
in response to obtaining a second operation, displaying and outputting a second configuration interface of the target communication module of the electronic device, at least one first signal parameters of the communication signal required to establish the target communication connection being configured by the configuration operation acting on at least one sub-control of the first control, at least one second signal parameters of the communication signal required to disconnect the target communication connection being configured through the at least one sub-control of the second control, the sub-control of the first control being arranged in the second configuration interface where the first control is located or a sub-interface of the second configuration interface, the sub-control of the second control being arranged in the second configuration interface where the second control is located or a sub-interface of the second configuration interface, the first signal parameter being the same as or different from the second signal parameter;
in response to obtaining a third operation, displaying and outputting a third configuration interface of the target communication module of the electronic device, the third configuration interface including a third control, at least one first signal parameter of the communication signal required to establish the target communication connection being configured by the configuration operation acting on the third control, or at least one first signal parameter of the communication signal required to establish the target communication connection being configured by the configuration operation acting on a sub-control of the third control, the sub-control of the third control being arranged in the third configuration interface or a sub-interface of the third configuration interface; or
in response to obtaining a fourth operation, displaying and outputting a fourth configuration interface of the target communication module of the electronic device, the fourth configuration interface including a fourth control, at least one second signal parameter of the communication signal required to disconnect the target communication connection being configured by the configuration operation acting on the fourth control, or at least one second signal parameter of the communication signal required to disconnect the target communication connection being configured by the configuration operation acting on a sub-control of the fourth control, the sub-control of the fourth control being arranged in the fourth configuration interface or a sub-interface of the fourth configuration interface.

4. The method of claim 1, wherein obtaining the target reference information includes one or more of:
obtaining the target reference information based on relative position data between the terminal device and the electronic device;
obtaining the target reference information based on a working parameter of a corresponding communication module of the terminal device and/or the electronic device;
obtaining the target reference information based on the signal parameter of the target communication signal between the target communication module or a target application of the electronic device and the terminal device, the target application being an application program for monitoring the signal parameter of the target communication signal; or
obtaining the target reference information based on a signal relay device arranged between the electronic device and the terminal device.

5. The method of claim 1, wherein controlling the communication connection state based on the connection configuration information corresponding to the terminal device and the target reference information includes:
obtaining the attribute information of the terminal device to determine the connection configuration information corresponding to the terminal device based on the attribute information; and
controlling the communication connection state with the terminal device based on a comparison result between the signal parameter represented by the target reference information and the connection configuration information.

6. The method of claim 5, wherein controlling the communication connection state based on the connection configuration information corresponding to the terminal device and the target reference information includes one or more of:
when the target communication connection is not established with the terminal device, obtaining the attribute information of the terminal device based on a connection request of the terminal device, determining first connection configuration information corresponding to the terminal device based on the attribute information, and establishing or not establishing the target communication connection with the terminal device based on a comparison result between the signal parameter and the first connection configuration information; or
when the target communication connection is established with the terminal device, obtaining the attribute information of the terminal device through the target communication connection, determining second connection configuration information corresponding to the terminal device based on the attribute information, and disconnecting or not disconnecting the target communication connection with the terminal device based on a comparison result between the signal parameter and the second connection configuration information.

7. The method of claim 6, wherein establishing or not establishing the target communication connection with the terminal device based on the comparison result between the signal parameter and the first connection configuration information includes one or more of:
if a relative distance between the terminal device and the electronic device is within a first distance range, do not establish the target communication connection with the terminal device;
if the relative distance between the terminal device and the electronic device is within a second distance range, establishing the target communication connection with the terminal device;
if signal strength of the target communication signal between the terminal device and the electronic device is within a first threshold range, do not establish the target communication connection with the terminal device; or
if the signal strength of the target communication signal between the terminal device and the electronic device is within a second threshold range, establishing the target communication connection with the terminal device.

8. The method of claim 7, wherein disconnecting or not disconnecting the target communication connection with the terminal device based on the comparison result between the signal parameter and the second connection configuration information includes one or more of:
if the relative distance between the terminal device and the electronic device is within a third distance range, disconnecting the target communication connection with the terminal device;
if the relative distance between the terminal device and the electronic device is within a fourth distance range, do not disconnect the target communication connection with the terminal device;
if the signal strength of the target communication signal between the terminal device and the electronic device is within a third threshold range, disconnecting the target communication connection with the terminal device; or
if the signal strength of the target communication signal between the terminal device and the electronic device is within a fourth threshold range, disconnect the target communication connection with the terminal device.

9. The method of claim 5, wherein controlling the communication connection state based on the connection configuration information corresponding to the terminal device and the target reference information includes one or more of:
if the signal strength of the target communication signal between the terminal device and the electronic device is within a fifth threshold range, controlling the target communication module of the electronic device to enter a first working state to be in a first communication connection state with the terminal device;
if the relative distance between the terminal device and the electronic device is within a fifth distance range, controlling the target communication module of the electronic device to enter a second working state to be in a second communication connection state with the terminal device;
if the terminal device is not unique, and the relative distance between at least one of the terminal devices and the electronic device is within the third distance range, controlling the target communication module of the electronic device to enter a third working state for the terminal device within the fourth distance range from the electronic device to be in a third communication connection state with the electronic device; or
if the terminal device is not unique, and the signal strength of the target communication signal between at least one of the terminal devices and the electronic device is within the third threshold range, controlling the target communication module of the electronic device to enter a fourth working state for the terminal device within the fourth threshold range with the electronic device to be in a fourth communication connection state with the electronic device.

10. The method of claim 5 further comprising:
controlling the communication connection state with the terminal device based on the relative distance between the signal relay device and the electronic device and/or the terminal device and/or the signal strength of the target communication signal, the signal relay device being arranged between the electronic device and the terminal device.

11. An electronic device comprising:
an information acquisition module, the information acquisition module being configured to obtain target reference information, the target reference information being used to at least characterize a signal parameter of a target communication signal between the electronic device and a terminal device; and
a state control module, the state control module being configured to control a communication connection state with the terminal device based on connection configuration information corresponding to the terminal device and the target reference information, wherein:
the connection configuration information is information of the communication signal required to configure the terminal device to establish or disconnect the target communication connection with the electronic device, and the connection configuration information configured for different terminal devices is the same or different.

12. Computer readable storage medium storing computer instructions, when executed by one or more processors, the computer instructions implementing a control method comprising:
obtaining target reference information, the target reference information being used to at least characterize a signal parameter of a target communication signal between an electronic device and a terminal device; and
controlling a communication connection state with the terminal device based on connection configuration information corresponding to the terminal device and the target reference information, wherein:
the connection configuration information is information of the communication signal required to configure the terminal device to establish or disconnect the target communication connection with the electronic device, and the connection configuration information configured for different terminal devices is same or different.

13. The computer readable storage medium of claim 12, wherein the communication signal required for configuring the terminal device to establish or disconnect the target communication connection with the electronic device includes one or more of:
inputting a target signal parameter for configuring the communication signal required to establish or disconnect the target communication connection on a configuration interface of a target communication module of the electronic device;
inputting the target signal parameter for configuring the communication signal required to establish or disconnect the target communication connection through a voice input module of the electronic device;
inputting the target signal parameter for configuring the communication signal required to establish or disconnect the target communication connection through target controls and/or physical keys arranged on the electronic device;
inputting the target signal parameter for configuring the communication signal required to establish or disconnect the target communication connection through an action recognition module of the electronic device; or
configuring the target signal parameter of the communication signal required to establish or disconnect the target communication connection based on attribute information of the terminal device.

14. The computer readable storage medium of claim 13, wherein inputting the target signal parameter for configuring the communication signal required to establish or disconnect the target communication connection on the configuration interface of the target communication module of the electronic device includes one or more of:
in response to obtaining a first operation, displaying and outputting a first configuration interface of the target communication module of the electronic device, the first configuration interface including a first control and a second control, a first signal parameter of the communication signal required to establish the target communication connection being configured by a configuration operation acting on the first control, a second signal parameter of the communication signal required to disconnect the target communication connection being configured by the configuration operation acting on the second control, the first signal parameter being the same as or different from the second signal parameter;
in response to obtaining a second operation, displaying and outputting a second configuration interface of the target communication module of the electronic device, at least one first signal parameters of the communication signal required to establish the target communication connection being configured by the configuration operation acting on at least one sub-control of the first control, at least one second signal parameters of the communication signal required to disconnect the target communication connection being configured through the at least one sub-control of the second control, the sub-control of the first control being arranged in the second configuration interface where the first control is located or a sub-interface of the second configuration interface, the sub-control of the second control being arranged in the second configuration interface where the second control is located or a sub-interface of the second configuration interface, the first signal parameter being the same as or different from the second signal parameter;
in response to obtaining a third operation, displaying and outputting a third configuration interface of the target communication module of the electronic device, the third configuration interface including a third control, at least one first signal parameter of the communication signal required to establish the target communication connection being configured by the configuration operation acting on the third control, or at least one first signal parameter of the communication signal required to establish the target communication connection being configured by the configuration operation acting on a sub-control of the third control, the sub-control of the third control being arranged in the third configuration interface or a sub-interface of the third configuration interface; or
in response to obtaining a fourth operation, displaying and outputting a fourth configuration interface of the target communication module of the electronic device, the fourth configuration interface including a fourth control, at least one second signal parameter of the communication signal required to disconnect the target communication connection being configured by the configuration operation acting on the fourth control, or at least one second signal parameter of the communication signal required to disconnect the target communication connection being configured by the configuration operation acting on a sub-control of the fourth control, the sub-control of the fourth control being arranged in the fourth configuration interface or a sub-interface of the fourth configuration interface.

15. The computer readable storage medium of claim 12, wherein obtaining the target reference information includes one or more of:
obtaining the target reference information based on relative position data between the terminal device and the electronic device;
obtaining the target reference information based on a working parameter of a corresponding communication module of the terminal device and/or the electronic device;
obtaining the target reference information based on the signal parameter of the target communication signal between the target communication module or a target application of the electronic device and the terminal device, the target application being an application program for monitoring the signal parameter of the target communication signal; or
obtaining the target reference information based on a signal relay device arranged between the electronic device and the terminal device.

16. The computer readable storage medium of claim 15, wherein controlling the communication connection state based on the connection configuration information corresponding to the terminal device and the target reference information includes:
obtaining the attribute information of the terminal device to determine the connection configuration information corresponding to the terminal device based on the attribute information; or
controlling the communication connection state with the terminal device based on a comparison result between the signal parameter represented by the target reference information and the connection configuration information.

17. The computer readable storage medium of claim 16, wherein controlling the communication connection state based on the connection configuration information corresponding to the terminal device and the target reference information includes one or more of:
when the target communication connection is not established with the terminal device, obtaining the attribute information of the terminal device based on a connection request of the terminal device, determining first connection configuration information corresponding to the terminal device based on the attribute information, and establishing or not establishing the target communication connection with the terminal device based on a comparison result between the signal parameter and the first connection configuration information; or
when the target communication connection is established with the terminal device, obtaining the attribute information of the terminal device through the target communication connection, determining second connection configuration information corresponding to the terminal device based on the attribute information, and disconnecting or not disconnecting the target communication connection with the terminal device based on a comparison result between the signal parameter and the second connection configuration information.

18. The computer readable storage medium of claim 17, wherein establishing or not establishing the target communication connection with the terminal device based on the comparison result between the signal parameter and the first connection configuration information includes one or more of:
if a relative distance between the terminal device and the electronic device is within a first distance range, do not establish the target communication connection with the terminal device;
if the relative distance between the terminal device and the electronic device is within a second distance range, establishing the target communication connection with the terminal device;
if signal strength of the target communication signal between the terminal device and the electronic device is within a first threshold range, do not establish the target communication connection with the terminal device; or
if the signal strength of the target communication signal between the terminal device and the electronic device is within a second threshold range, establishing the target communication connection with the terminal device; and/or,
disconnecting or not disconnecting the target communication connection with the terminal device based on the comparison result between the signal parameter and the second connection configuration information includes one or more of:
if the relative distance between the terminal device and the electronic device is within a third distance range, disconnecting the target communication connection with the terminal device;
if the relative distance between the terminal device and the electronic device is within a fourth distance range, do not disconnect the target communication connection with the terminal device;
if the signal strength of the target communication signal between the terminal device and the electronic device is within a third threshold range, disconnecting the target communication connection with the terminal device; or
if the signal strength of the target communication signal between the terminal device and the electronic device is within a fourth threshold range, disconnect the target communication connection with the terminal device.

19. The computer readable storage medium of claim 16, wherein controlling the communication connection state based on the connection configuration information corresponding to the terminal device and the target reference information includes one or more of:
if the signal strength of the target communication signal between the terminal device and the electronic device is within a fifth threshold range, controlling the target communication module of the electronic device to enter a first working state to be in a first communication connection state with the terminal device;
if the relative distance between the terminal device and the electronic device is within a fifth distance range, controlling the target communication module of the electronic device to enter a second working state to be in a second communication connection state with the terminal device;
if the terminal device is not unique, and the relative distance between at least one of the terminal devices and the electronic device is within the third distance range, controlling the target communication module of the electronic device to enter a third working state for the terminal device within the fourth distance range from the electronic device to be in a third communication connection state with the electronic device; or
if the terminal device is not unique, and the signal strength of the target communication signal between at least one of the terminal devices and the electronic device is within the third threshold range, controlling the target communication module of the electronic device to enter a fourth working state for the terminal device within the fourth threshold range with the electronic device to be in a fourth communication connection state with the electronic device.

20. The computer readable storage medium claim 16, the method further comprising:
controlling the communication connection state with the terminal device based on the relative distance between the signal relay device and the electronic device and/or the terminal device and/or the signal strength of the target communication signal, the signal relay device being arranged between the electronic device and the terminal device.
